(19) United States
(12) Patent Application Publication
(10) Pub. No.: US 2026/0095389 A1
(43) Pub. Date: Apr. 2, 2026

(54) METHODS AND DEVICES FOR MACHINE LEARNING (ML) MODEL INFERENCE IMPACT MANAGEMENT

(71) Applicant: Samsung Electronics Co., Ltd., Suwon-si (KR)

(72) Inventors: Deepanshu GAUTAM, Bangalore (IN); Ashutosh KAUSHIK, Bangalore (IN); Karthikeyan SUBRAMANIAM, Bangalore (IN)

(21) Appl. No.: 19/341,749

(22) Filed: Sep. 26, 2025

Related U.S. Application Data
(63) Continuation of application No. PCT/KR2025/015091, filed on Sep. 25, 2025.

(30) Foreign Application Priority Data
Oct. 1, 2024 (IN) 202441074452
Sep. 15, 2025 (IN) 2024 41074452

(51) Int. Cl. H04L 41/16; H04W 24/02

(52) U.S. Cl. CPC H04L 41/16; H04W 24/02

(57) ABSTRACT

Methods and devices for machine learning (ML) inference impact management in mobile networks and telecommunication networks are provided. The method includes receiving from a management service (MnS) producer, an inference report including impact information indicative of performance impact caused by one or more ML models deployed in a communication network and historical inference reports, detecting an occurrence of a performance degradation event in the communication network based on the impact information, identifying at least one target ML model from the one or more ML models which is causing the performance degradation event, based on the impact information and the historical inference reports, and performing one or more actions for managing the performance impact caused due to the at least one target ML model.

### CROSS-REFERENCE TO RELATED APPLICATION(S)

This application is a continuation application, claiming priority under 35 U.S.C. § 365 (c), of an International application No. PCT/KR2025/015091, filed on Sep. 25, 2025, which is based on and claims the benefit of an Indian Provisional patent application No. 202441074452, filed on Oct. 1, 2024, in the Indian Intellectual Property Office, and of an Indian Complete patent application No. 202441074452, filed on Sep. 15, 2025, in the Indian Intellectual Property Office, the disclosure of each of which is incorporated by reference herein in its entirety.

### FIELD OF THE INVENTION

The disclosure relates to the application of artificial intelligence/machine learning (ML) techniques to telecommunication networks. More particularly, the disclosure relates to methods and devices for ML model Inference Impact Management in a communication network.

### BACKGROUND

3rd generation partnership project (3GPP) technical specification (TS) 28.104 defines the framework, functions, capabilities, use cases, and requirements for management data analytics (MDA) in fifth generation (5G) networks. TS 28.104 specifically addresses how analytics data are collected, processed, provided, and consumed by management systems for operational assurance, optimization, and planning. 3GPP TS 28.105 specifies the capabilities and services needed for managing artificial intelligence/machine learning AI/ML in 5G networks (5GS), including how ML models are trained, deployed, tested, and used for inference.

The AI/ML models and its relevant applications are increasingly being adopted in the telecommunication industry including mobile networks. However, some of the relevant aspects of the technology are still evolving. Several trained ML models of the related art may be in use in a communication network with each one of them influencing network performance. Network Functions associated with these ML models are monitored to ensure whether the network is running optimally with these models in use. Yet, existing management provisions are still limited and do not enable identification of the ML Model that may cause non-optimal performance of the network.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide an application of artificial intelligence/machine learning (ML) techniques to telecommunication networks.

Another aspect of the disclosure is to provide a method and system for ML Inference Impact Management to enable operators to identify the ML models that are causing a specific sub-optimal behavior in the network. Once the ML model is identified, remedial actions can be taken to mitigate performance degradation. This includes deactivating or updating the particular ML model inference functionality in the network to avoid any further performance degradation.

Additional aspects will be set forth in part in the description which follows and, in part, will be apparent from the description, or may be learned by practice of the presented embodiments.

In accordance with an aspect of the disclosure, a method of managing impact of machine learning (ML) model inferences in a communication network is provided. The method includes receiving from a management service (MnS) producer, an inference report including impact information indicative of performance impact caused by one or more ML models deployed in a communication network and historical inference reports, detecting an occurrence of a performance degradation event in the communication network based on the impact information, identifying at least one target ML model from the one or more ML models which is causing the performance degradation event, based on the impact information and the historical inference reports, and performing one or more actions for managing the performance impact caused due to the at least one target ML model.

In accordance with another aspect of the disclosure, a management service (MnS) consumer to manage impact of machine learning (ML) model inferences in a communication network is provided. The MnS consumer includes memory, including one or more storage media, storing instructions, and at least one processor coupled to the memory, wherein the instructions, when executed by the at least one processor individually or collectively, cause the MnS consumer to receive from an MnS producer, an inference report including impact information indicative of performance impact caused by one or more ML models deployed in a communication network and historical inference reports, detect an occurrence of a performance degradation event in the communication network based on the impact information, identify at least one target ML model from the one or more ML models which is causing the performance degradation event, based on the impact information and the historical inference reports, and perform one or more actions for managing the performance impact caused due to the at least one target ML model.

In accordance with another aspect of the disclosure, a method of generating impact information associated with a performance of a communication network is provided. The method includes generating impact information indicative of performance impact caused by one or more ML models deployed in a communication network and generating an inference report based on the generated impact information.

In accordance with another aspect of the disclosure, a management service (MnS) producer to generate impact information associated with a performance of a communication network is disclosed. The MnS producer includes memory, including one or more storage media, storing instructions, and at least one processor coupled to the memory, wherein the instructions, when executed by the at least one processor individually or collectively, cause the MnS producer to generate impact information indicative of performance impact caused by one or more ML models deployed in a communication network and generate an inference report based on the generated impact information.

In accordance with another aspect of the disclosure, one or more non-transitory computer-readable storage media storing one or more computer programs including computer-executable instructions that, when executed by one or more processors of an electronic device individually or collectively, cause the electronic device to perform operations are provided. The operations include receiving from an MnS producer, an inference report comprising impact information indicative of performance impact caused by one or more ML models deployed in a communication network and historical inference reports, detecting an occurrence of a performance degradation event in the communication network based on the impact information, upon detection of the performance degradation event, identifying at least one target ML model from the one or more ML models which is causing the performance degradation event, based on the impact information and the historical inference reports, and performing one or more actions for managing the performance impact caused due to the at least one target ML model.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages certain embodiments of the disclosure will be more apparent from the following description taken in conjunction with the accompanying drawings, in which:

FIG. 1A illustrates a network environment 100-1 depicting various network entities and ML models deployed in a communication network, according to an embodiment of the disclosure;

FIG. 1B illustrates a environment 100-2 describing a procedure for ML model management in a communication network, according to an embodiment of the disclosure;

FIG. 2 illustrates a sequence diagram 200 describing a procedure ML model inference impact management in a communication network, according to an embodiment of the disclosure;

FIG. 3 shows a flow chart of a method 300 of managing impact of Machine Learning (ML) model inferences in a communication network, according to an embodiment of the disclosure;

FIG. 4 shows a flow chart of a method 400 of generating impact information associated with a performance of a communication network, according to an embodiment of the disclosure; and

FIG. 5 illustrates a block diagram of a computer system implementing the techniques disclosed according to an embodiment of the disclosure.

Throughout the drawings, it should be note that like reference numbers are used to depict the same or similar features, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding, but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but are merely used by the inventor to enable a clear and consistent understanding of the disclosure. Accordingly, it should be apparent to those skilled in the art that the following description of various embodiments of the disclosure is provided for illustration purposes only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

The artificial intelligence/machine learning (AI/ML) techniques and relevant applications are being increasingly adopted by the wider industries and proved to be successful. These are now being applied to telecommunication industry including mobile networks. Although AI/ML techniques in general are quite mature nowadays, some of the relevant aspects of the technology are still evolving while new complementary techniques are frequently emerging. The machine learning methods in general include supervised learning, semi-supervised learning, unsupervised learning and reinforcement learning. Each learning method fits one or more specific category of inference (e.g. prediction) and requires specific type of training data.

The lifecycle management of AI/ML model is being defined in 3GPP SA5 working group. The lifecycle stages include ML model training, ML testing, ML emulation, ML entity loading and Inference phase. ML model training includes initial training and re-training, of an ML model or a group of ML models. It also includes validation of the ML entity to evaluate the performance when the ML entity performs on the training data and validation data. If the validation result does not meet the expectation (e.g., the variance is not acceptable), the ML model associated with that entity needs to be re-trained. The ML model training is the initial phase of the workflow. ML testing includes testing of the validated ML entity to evaluate the performance of the trained ML model when it performs on testing data. If the testing result meets the expectation, the ML entity may proceed to the next phase, otherwise the ML model associated with that entity may need to be re-trained. ML emulation includes running an ML entity for inference in an emulation environment. The purpose is to evaluate the inference performance of the ML entity in the emulation environment prior to applying it to the target network or system. ML entity loading includes the process (a.k.a. a sequence of atomic actions) of making a trained ML entity available for use at the target AI/ML inference function. Further, the AI/ML inference includes performing inference using a trained ML entity by the AI/ML inference function.

Several trained ML models may be in use in an operator network with each one of them influencing network performance. The Network Functions with these ML models are monitored to ensure network is running optimally with these models in use. Key performance indicators (KPIs) for evaluating runtime performance of Network Functions using ML models are provided for this purpose. Actions may need to be taken by a network operator once an ML trained model has been identified that is contributing towards non-optimal running of the network. These actions may involve for example, without service interruptions, reverting to running of the network without ML based optimizations or replacing current ML model with an earlier model one that was performing better. Existing management provisions do not enable identifying the ML Model that are causing non-optimal performance of the network.

Therefore, there is a need for a solution that can effectively identify the ML Models that are causing non-optimal performance of the network.

The disclosure provides a method and system for ML Inference Impact Management. According to the first embodiment, the disclosure discloses a method that may require providing additional information in the ML Inference Report. This information may specify the potential network impacts due to the inference output result. This information may include historical inference reports. This information may then enable an authorized consumer to a) take an informed decision about the inference output result b) identify the ML model that is causing a particular non-optimal performance in the network at some future point of time. The consumer may then decide to either deactivate the inference or update the inference function properties to mitigate the performance degradation. The information may be added as part of InferenceReport as defined in 3GPP TS 28.105 and will be modeled as a new datatype called PotentialImpactsInfo. This data type may include, but not limited to:
1. Inference output result: This may specify the attribute value pair for each of the attributes defined in the analytics output for the particular MDA type identified by the attribute aIMLInferenceName.
2. AffectedScope: This may specify the scope of affect the inference output may have. For instance, AffectedScope may include, but not limited to:
   a. Identifier of the network functions that may be affected by the output result of the inference function. This will be in the form of a distinguished name (DN).
   b. A Geographical location indicating that all the network function in that location may be affected by the inference output result.
   c. A time duration indicating that all the related network function may be affected during this time duration by the inference output result.
3. AffectedPD (performance data): This identifies the potential performance data (performance measurement (PM) and KPI as defined in 3GPP TS 28.552 and 28.554 respectively) that may be affected in a non-optimal way due to the recommendations/configurations provided as part of inference output result.
   a. PDIdentifier: This identifies the performance data or the KPI that may be affected. This will be the name of PM and KPI as defined in 3GPP TS 28.552 and 28.554, respectively.
   b. ExpectedPDValues: This specifies the potential non-optimal value of the performance data or the management data.

According to the disclosure, the method and system proposed enables operators to identify the ML models that are causing a specific sub-optimal behavior in the network. Once the ML model is identified the remedial actions can be taken to mitigate performance degradation. This may include deactivating or updating the particular ML model inference functionality in the network to avoid any further performance degradation.

According to the disclosure, a procedure for MnS management is described. The procedure may include interactions between a provisioning management service (MnS) consumer, provisioning MnS producer and managed network function. In an embodiment the procedure may include the following steps:

At operation 1, the ML model gets trained, tested and deployed as per the mechanism defined in 3GPP TS 28.105. At operation 2, the provisioning MnS consumer sends the request to activate the ML inference at the node where the ML model was deployed. At operation 3, the inference gets initiated. Thereafter, at operation 4, the provisioning MnS producer sends the acknowledgment. At operation 5, the provisioning MnS producer generates the Inference report with the information on the potential network impact as defined in of the embodiment here. At operation 6, the provisioning MnS consumer is then notified about the availability of the report. At operation 7, provisioning MnS consumer sends a query request to read the inference report generated by the producer. At operation 8, the provisioning MnS producer sends the response with the information. At operation 9, performance degradation is detected by the consumer utilizing the existing performance assurance mechanism defined in 3GPP TS 28.622. In this process the performance measurements are collected only from the managed functions that are actively using ML models i.e. the managed functions objects which are having the child object of AIMLInferenceFunction. At operation 10, the provisioning MnS consumer checks the historical inference report information to identify the ML model(s) whose inference may be causing the performance degradation based on the information on the potential network impact provided as part of inference report. If multiple ML models are identified, by the historical inference reports, as the potential source of performance de-gradation then the consumer decides the target ML model based on the local priorities. At operation 11, once the ML model(s) is identified, the provisioning MnS consumer deactivates the ML inference. Alternatively, at operation 12, consumer may choose to update the ML inference producer send the acknowledgment. At operation 13, the provisioning MnS sends the acknowledgment.

In some embodiments, the solution disclosed in the disclosure requires providing the additional information in the ML inference report. This information will specify the potential network impacts due to the inference output result. This information can then enable an authorized consumer to a) take an informed decision about the inference output result b) identify the ML model that is causing a particular non-optimal performance in the network at some future point of time. The consumer can then decide to either deactivate the inference or update the inference function properties to mitigate the performance degradation. The information will be added as part of InferenceReport as defined in 3GPP TS 28.105 and will be modeled as a new datatype called PotentialImpactsInfo. This data type may include, but is not limited to:

Inference output result: This may specify the attribute value pair for each of the attributes defined in the analytics output for the particular MDA type identified by the attribute aIMLInferenceName.

AffectedScope: This may specify the scope of affect the inference output may have. For instance, AffectedScope may include, but not limited to:
a) Identifier of the network functions that may be affected by the output result of the inference function. This will be in the form of a DN.
b) A Geographical location indicating that all the network function in that location may be affected by the inference output result.
c) A time duration indicating that all the related network function may be affected during this time duration by the inference output result.

AffectedPD (performance data): This identifies the potential performance data (performance measurement and KPI as defined in 3GPP TS 28.552 and 28.554 respectively) that may be affected in a non-optimal way due to the recommendations/configurations provided as part of inference output result.
a) PDIdentifier: This identifies the performance data or the KPI that may be affected. This will be the name of PM and KPI as defined in 3GPP TS 28.552 and 28.554, respectively.
b) ExpectedPDValues: This specifies the potential non-optimal value of the performance data or the management data.

In some embodiments, the basic assumption here may be that the recommendation provided as part of inference output result (i.e., provided MDA recommendations) may cause some sub-optimal network conditions. The following Table 1 shows examples of some of the configuration recommendations that various MDA analytics provide and what PM data it may have effect on.

TABLE 1

| | Recommended | Potential PM |
|---|---|---|
| InferenceName/MDT Type (28.104) | Configurations | Impact |
| CoverageAnalytics.CoverageProblemAnalysis. | Creation of new | Energy |
| | beam(s), or | Consumption |
| | cell(s); | may increase. |
| | Change the | |
| | transmission | |
| | power of the NR | |
| | sector carrier; | |
| | Delete some | |
| | unwanted beam(s) | |
| | or cell(s). | |
| MDAAssistedFaultManagement.FailurePrediction. | Update 5GC NF | Update to |
| | (e.g., AMF and | servingScope |
| | SMF) profile | may result in |
| | | coverage |
| | | hole. |
| ResourceAnalytics.virtualizedResourceUtilizationAnalysisNF | scale in a list of | In case of |
| | NFs; | scale out |
| | scale out a list of | Energy |
| | NFs. | Consumption |
| | | may increase. |
| | | In case of |
| | | scale in, |
| | | considering |
| | | the traffic |
| | | projections, |
| | | the |
| | | throughput |
| | | may decrease. |
| ResourceAnalytics.PhyiscalResourceUtilizationAnalysisNF | optimizing the | In case of |
| | capacity of gNB | increasing |
| | (e.g., increasing or | resources |
| | decreasing | Energy |
| | physical resources | Consumption |
| | | may increase. |
| ResourceAnalytics.5GCControlPlaneCongestionAnalysis | scale out a list of | Energy |
| | 5GC NFs | Consumption |
| | | may increase. |
| MDAAssistedEnergySaving.EnergySavingAnalysis | For ES on NR | Switching |
| | cells. It may | energy saving |
| | contain a set of: | state ON my |
| | Recommended | reduce |
| | NR Cell (ES-Cell) | Throughput |
| | to enter | and increase |
| | energySaving | latency. |
| | state. | |
| | Recommended | |
| | candidate cells | |
| | with precedence | |
| | for taking over the | |
| | traffic of the ES- | |
| | Cell. | |
| | The time to enter | |
| | and terminate the | |
| | energy saving | |
| | state. | |
| | The load | |
| | threshold to enter | |
| | and terminate the | |
| | energy saving | |
| | state for the ES- | |
| | Cell. | |

The disclosure enables operators to identify the ML models that are causing particular sub-optimal behavior in the network with the help of the new set of information related with AffectedScope and AffectedPD attributes. Once the ML model is identified the remedial actions can be taken to mitigate performance degradation. This may include deactivating or updating the particular ML model inference functionality in the network avoiding any further performance degradation.

In the disclosure, the word “exemplary” is used herein to mean “serving as an example, instance, or illustration”. Any embodiment or implementation of the subject matter described herein as “exemplary” is not necessarily to be construed as preferred or advantageous over other embodiments.

While the disclosure is susceptible to various modifications and alternative forms, specific embodiment thereof has been shown by way of example in the drawings and will be described in detail below. It should be understood, however, that it is not intended to limit the disclosure to the particular forms disclosed, but on the contrary, the disclosure is to cover all modifications, equivalents, and alternative falling within the spirit and the scope of the disclosure.

In the following detailed description of the embodiments of the disclosure, reference is made to the accompanying drawings that form a part hereof, and in which are shown by way of illustration specific embodiments in which the disclosure may be practiced. These embodiments are described in sufficient detail to enable those skilled in the art to practice the disclosure, and it is to be understood that other embodiments may be utilized and that changes may be made without departing from the scope of the disclosure. The following description is, therefore, not to be taken in a limiting sense.

The terms “comprise(s)”, “comprising”, “include(s)”, or any other variations thereof, are intended to cover a non-exclusive inclusion, such that a setup, device, apparatus, system, or method that comprises a list of components or steps does not include only those components or steps but may include other components or steps not expressly listed or inherent to such setup or device or apparatus or system or method. In other words, one or more elements in a device or system or apparatus preceded by “comprises . . . a” does not, without more constraints, preclude the existence of other elements or additional elements in the device, system, or apparatus.

The terms like “at least one” and “one or more” may be used interchangeably throughout the description. The terms like “a plurality of” and “multiple” may be used interchangeably throughout the description. It is to be appreciated that the interchangeable terms disclosed in foregoing paragraphs may be used repeatedly throughout the disclosure. However, the same shall not be construed limiting the scope of the disclosure in any sense.

For the purpose of disclosure, the following 3GPP specifications: TS 28.104, TS 28.105, TS 28.552, TS 28.554 and TS 28.535 may be considered as relevant state of the art. 3GPP services and system aspects (SA) working group 5 defines AI/ML management including the lifecycle management of an ML model. Particularly the main stages of an ML model lifecycle is specified by 3GPP in specification TS 28.105.

Typically, the lifecycle stages of an ML model include ML model training, ML testing, ML emulation, ML entity loading and ML inference phase. The initial stage is ML model training that includes initial training and re-training, of an ML model or a group of ML models. The stages also include validation of the ML entity to evaluate the performance when the ML entity performs on the training data and validation data. If the validation result does not meet the expectation (e.g., the variance is not acceptable), the ML model associated with that entity needs to be re-trained. The ML model training is the initial phase of the workflow. The ML entity loading is another phase that includes the process of making a trained ML entity available for use at a target AI/ML inference function. The AI/ML inference phase includes performing inference using a trained ML entity by the AI/ML inference function.

Further, an ML model may provide a recommendation to fulfill its core objective. The recommendation provided by the ML model may be to configure/re-configure the network. For example, ML model-A may have a core objective of coverage optimization and may recommend configurations to the network to create new beams to cover a particular coverage hole. Similarly, a ML model-B may have a core objective of optimal usage of resources and may recommend configurations to scale-in the virtual resource of a particular network function.

However, it may be noted that a particular recommendation provided by the ML model may result in an occurrence of a performance degradation event. Here, the performance degradation event is any event that potentially impacts a key performance indicator (KPI) of the network. These KPIs indicate performance measurement (PM) data which is calculated according to the formula specified in the key performance indicator definition. It represents an indicator of the network performance. KPIs, may be categorized into one or more categories such as accessibility, integrity, utilization, retainability, mobility, energy efficiency, reliability, air-interface efficiency, availability and the like. The 3GPP TS 28.554 specifies all end-to-end KPIs for a 5G network.

According to 3GPP TS 28.104 management data analytics (MDA), is defined as a foundational capability for mobile networks and services management and orchestration.

The MDA provides a capability of processing and analyzing data related to network and service events and status including e.g., performance measurements, KPIs, network analytics data, etc. to provide analytics output. The MDA output is provided by the management data analytics service (MDAS) producer. The MDAS is consumed by management service (MnS) consumers that requested the analytics from the MDAS or MDA MnS producers. The terms MDAS and MDA MnS are equivalent and may be used interchangeably throughout the document. MDA MnS consumer can request the MDA MnS producer to provide MDA output for a list of specified MDA type of analytics, i.e., MDA type, which corresponds to an MDA capability, which is to support analytics for a set of data or analytics for a certain PM, KPI or other data.

The table below shows the potential PM impact and recommended configurations provided by a ML model based on a specific MDA Type:

TABLE 2

| | Recommended | |
|---|---|---|
| | Configurations | Potential PM |
| MDA Type | by a ML model | Impact |
| CoverageAnalytics.CoverageProblemAnalysis. | Creation of new | Energy |
| | beam(s), or | Consumption |
| | cell(s); | may increase. |
| | Change the | |
| | transmission | |
| | power of the NR | |
| | sector carrier; | |
| | Delete some | |
| | unwanted beam(s) | |
| | or cell(s). | |
| MDAAssistedFaultManagement.FailurePrediction. | Update 5GC NF | Update to |
| | (e.g., AMF and | servingScope |
| | SMF) profile | may result in |
| | | coverage |
| | | hole. |
| ResourceAnalytics.virtualizedResourceUtilizationAnalysisNF | scale in a list of | In case of |
| | NFs; | scale out |
| | scale out a list of | Energy |
| | NFs. | Consumption |
| | | may increase. |
| | | In case of |
| | | scale in, |
| | | considering |
| | | the traffic |
| | | projections, |
| | | the |
| | | throughput |
| | | may decrease. |
| ResourceAnalytics.PhyiscalResourceUtilizationAnalysisNF | optimizing the | In case of |
| | capacity of gNB | increasing |
| | (e.g., increasing or | resources |
| | decreasing | Energy |
| | physical resources | Consumption |
| | | may increase. |
| ResourceAnalytics.5GCControlPlaneCongestionAnalysis | scale out a list of | Energy |
| | 5GC NFs | Consumption |
| | | may increase. |
| MDAAssistedEnergySaving.EnergySavingAnalysis | For ES on NR | Switching |
| | cells. It may | energy saving |
| | contain a set of: | state ON my |
| | Recommended | reduce |
| | NR Cell (ES-Cell) | Throughput |
| | to enter | and increase |
| | energySaving | latency. |
| | state. | |
| | Recommended | |
| | candidate cells | |
| | with precedence | |
| | for taking over the | |
| | traffic of the ES- | |
| | Cell. | |
| | The time to enter | |
| | and terminate the | |
| | energy saving | |
| | state. | |
| | The load | |
| | threshold to enter | |
| | and terminate the | |
| | energy saving | |
| | state for the ES- | |
| | Cell. | |

Referring back to the above example of ML model-A having the core objective of coverage optimization. Here, the associated PM impact for ML model-A may cause increased energy consumption as the new beam may result in more computation and thereby more energy consumption. Similarly, the ML model-B having the core objective of resource utilization. The associated PM impact for ML model-B may cause increased throughput because if the resources are reduced, the throughout may eventually increase.

Therefore, as explained in the background section, ML models in a network may potentially cause occurrence of performance degradation event in a network. Thus, it is crucial for any operator to identify such ML models that causes the performance degradation event and are impacting the network performance. There is no mechanism provided in the current state of art, to identify such ML models which are causing non-optimal performance in the network.

The disclosure provides techniques for ML model inference impact management that facilitates the identification of ML models that are causing non-optimal performance in the network.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a wireless fidelity (Wi-Fi) chip, a Bluetooth® chip, a global positioning system (GPS) chip, a near field communication (NFC) chip, connectivity chips, a sensor controller, a touch controller, a finger-print sensor controller, a display driver integrated circuit (IC), an audio CODEC chip, a universal serial bus (USB) controller, a camera controller, an image processing IC, a microprocessor unit (MPU), a system on chip (SoC), an IC, or the like.

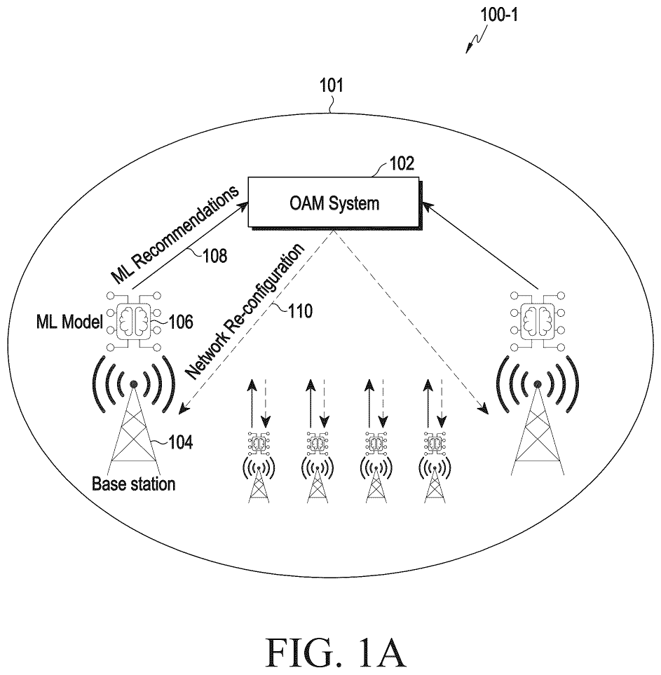

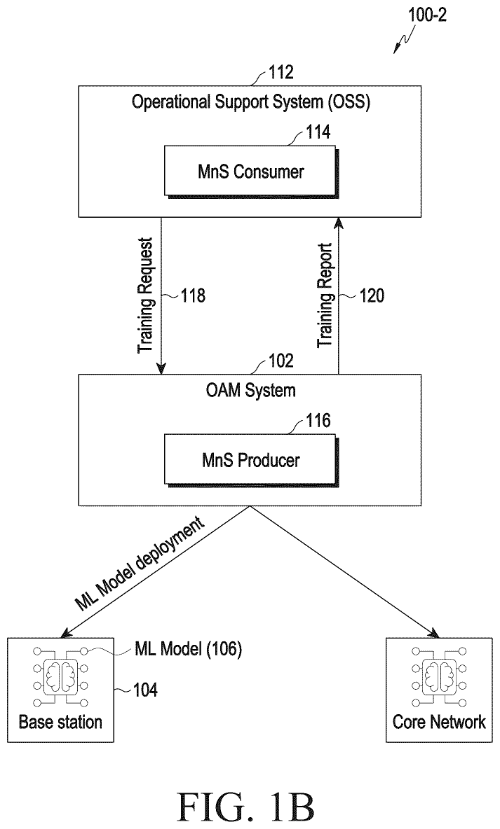

FIG. 1A illustrates a network environment 100-1 depicting various network entities in a communication network 101, according to an embodiment of the disclosure.

FIG. 1A depicts an Operation, Administration and Maintenance (OAM) system 102 that is configured to monitor and manage the communication network 101. The communication network 101 includes multiple network nodes/entities, for instance a base station 104 is depicted. Each of these network entities may be deployed with one or more machine learning (ML) models 106. The ML models 106 provide recommendations 108 to the OAM system 102 and the OAM system 102 in turn provides network re-configuration settings 110 to configure-reconfigure the network 101.

FIG. 1B illustrates a environment 100-2 describing a procedure for ML model management in the communication network 101, according to an embodiment of the disclosure.

FIG. 1B depicts an operations support system (OSS) 112, which is a centralized system used by network operators to manage, monitor, and operate network infrastructure. The OSS 112 manages network inventory, service provisioning, fault management, configuration and performance and network analytics and optimization. An MnS consumer 114 defined in the above sections, is part of the OSS 112. The MnS consumer 114 transmits a training request 118 to a MnS producer 116 to train a particular ML model 106. The MnS producer 116 provisions the training of the ML model 106 and transmits a training report 120 to the MnS consumer 114. The MnS producer 116 is deployed in the OAM system 102. Upon receiving the training report, the OAM system 102 deploys the trained ML model 106 at the appropriate network entity in the communication network 101, for instance the base station 104.

The disclosure particularly provides a mechanism in which the MnS consumer 114 can identify an ML model that is causing the particular performance degradation event. The MnS producer 116 provides additional impact information in a ML inference report to the MnS consumer 114. This information specifies the potential network impact caused by inference output result of a particular ML model and enables the MnS consumer 114 to identify the ML model that is causing a particular non-optimal performance. Upon identification, the MnS consumer 114 can then decide to either deactivate or update the inference function properties of the identified ML model to mitigate the performance degradation.

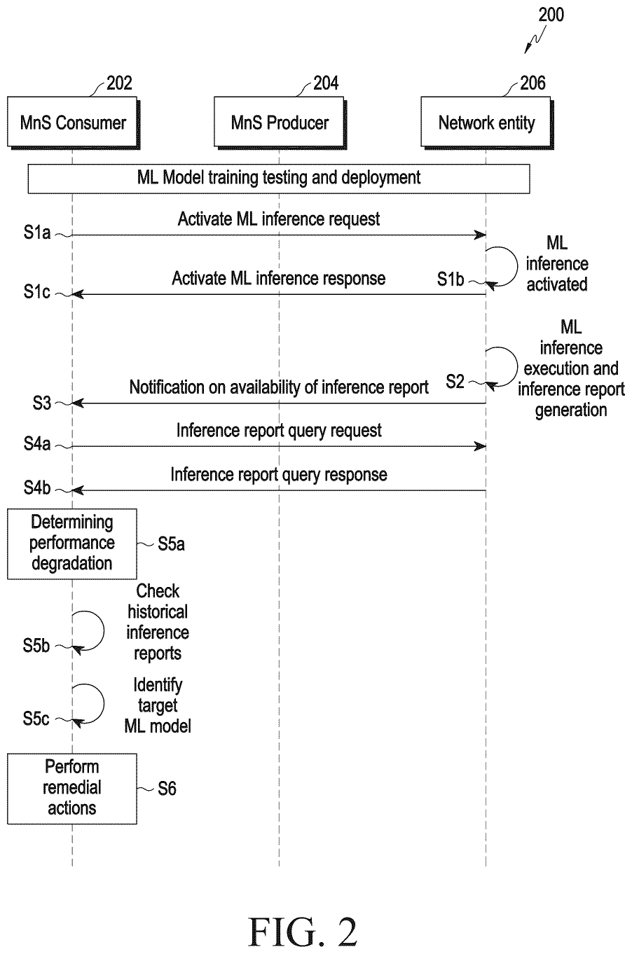

FIG. 2 illustrates a sequence diagram 200 describing a procedure for ML model inference impact management in a communication network, according to an embodiment of the disclosure.

Referring to FIG. 2, in 3GPP TS 28.105, an inference of an ML model is represented as managed function known as AIMLInferenceFunction. The AI/ML inference function is a function of the trained ML model(s) that enables it to conduct inference. The AIMLInferenceFunction indicates execution of a trained ML model on input data to generate predictions or decisions. The AIMLInferenceFunction may generate one or more AIMLInferenceReport(s). Each AIMLInferenceReport provides information about inference outputs from one or more ML models. The AIMLInferenceReport instance is created by the MnS producer 116 when creating an AIMLInferenceFunction instance.

The procedure of ML model inference impact management illustrated in FIG. 2 depicts various steps. The procedure starts once the ML model gets trained, tested and deployed as per the mechanism defined in 3GPP TS 28.105.

At operation Sla an MnS consumer 202 sends the request to activate the ML inference at a network entity 206 (analogous to base station 104) where the ML model is deployed. At operation S1b the inference is activated, and the associated inference function begins execution. At operation S1c, the MnS consumer 202 receives the response to the activation request sent in operation S1a.

The MnS producer 204 upon receiving update from the network entity 206 regarding execution of the inference function, generates the Inference report comprising a new datatype referred as impact information in operation S2.

The impact information is part of InferenceReport as defined in 3GPP TS 28.105 and is a new datatype also referred as PotentialImpactsInfo. The data type includes following attributes:
a) Inference output result: The attribute specifies the attribute value pair for each of the attributes defined in an analytics output for the particular management data analytics (MDA) type identified by the attribute aIMLInferenceName.
b) AffectedScope: The attribute specifies the scope of impact the inference output may have. The attribute includes:
   i. identifier of the network functions that may be impacted by the output result of the inference function. This will be in form of a DN.
   ii. A geographical location indicating that all the network function in that location may be impacted by the inference output result.
   iii. A time duration indicating that all the related network function may be impacted during this time duration by the inference output result.
c) AffectedPM: The attribute specifies the potential performance data that may be impacted in a non-optimal way due to the recommendations/configurations provided as part of inference output result. The attribute includes:
   i. PMIdentifier: This identifies the performance data or the key performance indicator (KPI) that may be impacted. This will be the name of performance measurement and KPI as defined in 3GPP TS 28.552 and 28.554, respectively.
   ii. ExpectedPMValues: This specifies the potential non-optimal value of the performance data.

At operation S3, the MnS consumer 202 is notified about the availability of the inference report. At operation S4a the MnS consumer 202 sends a query request to read the inference report generated by the MnS producer 204. At operation S4b the MnS producer 204 sends the response with the new data type-impact information.

Upon receiving the impact information, at operation S5a a performance degradation is detected by the MnS consumer 202 utilizing an existing performance assurance mechanism defined in 3GPP TS 28.622 and 28.532. The performance measurements are collected from the managed functions that are actively using ML models i.e., the managed functions objects which are having the child object of AIMLInferenceFunction.

At operation S5b, the MnS consumer 202 checks the historical inference report information and at operation S5c identifies target ML model(s) whose inference may be causing the performance degradation based on the impact information provided as part of inference report. If multiple target ML models are identified, by the historical inference reports, then the MnS consumer 202 decides one target ML model based on local priorities.

At operation S6, once the target ML model(s) are identified, the MnS consumer 202 performs one or more remedial actions. The remedial actions include, but not limited to, deactivating the ML inference function of the target ML model or updating the ML inference function of the target ML model.

For instance, if an ML model is targeting a particular geographical location and the energy consumption of the entities of that particular location is high. Then, an update may be made to update the geographical location associated with the ML model, so as to minimize the energy consumption.

In another embodiment, the decision to update or deactivate the inference function depends on one or more criterion of the ML model. The decisionConfidenceScore associated with a ML model may be utilized in determining the decision to update or deactivate. According to 3GPP specification 28.105, decisionConfidenceScore is the numerical value that represents the dependability/quality of a given decision generated by the AI/ML inference function of an ML model. The lowest value indicates the lowest level of dependability of the decisions, i.e., that the data is not usable at all. In an embodiment, the decisionConfidenceScore may be a value from 0-100. Therefore, for ML models whose decisionConfidenceScore may be less than a minimum threshold value may be deactivated as they have low confidence scores associated with their decisions, while ML models whose decisionConfidenceScore may be greater than the minimum threshold value may be updated. Considering the minimum threshold value is 10, then all ML models having decisionConfidenceScore less than 10 may be deactivated and having decisionConfidenceScore more than or equal to 10 may be updated.

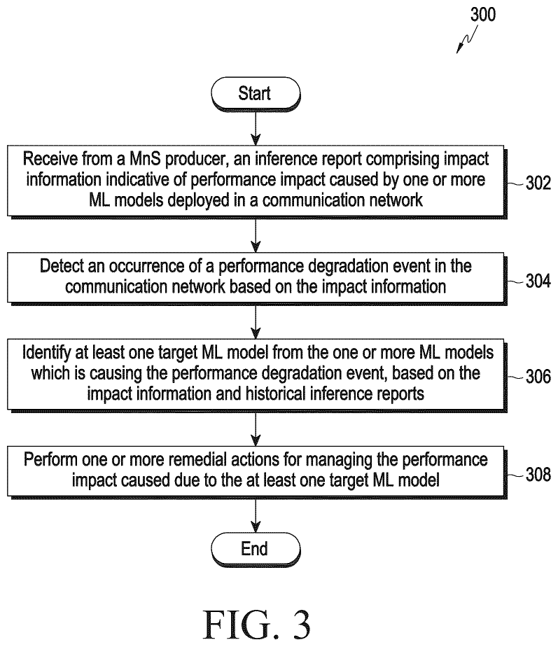

FIG. 3 shows a flow chart of a method 300 of managing impact of machine learning (ML) model inferences in a communication network, according to an embodiment of the disclosure.

Referring to FIG. 3, the method 300 includes one or more steps. The method 300 may be described in the general context of computer executable instructions. Generally, computer executable instructions can include routines, programs, objects, components, data structures, procedures, modules, and functions, which perform particular functions or implement particular abstract data types. In one embodiment, the functionalities of the method may be performed by a MnS consumer 202 or the at least one processor of a MnS consumer 202.

The order in which the method 300 is described is not intended to be construed as a limitation, and any number of the described method blocks can be combined in any order to implement the method. Additionally, individual blocks may be deleted from the methods without departing from the scope of the subject matter described herein. Furthermore, the method can be implemented in any suitable hardware, software, firmware, or combination thereof.

At operation 302, an inference report is received from a MnS producer 204. The inference report comprises impact information indicative of performance impact caused by one or more ML models deployed in a communication network. The impact information comprises a set of attributes comprising an inference name, an affected scope, and an affected performance measurement (affected PM). The affected scope attribute at least includes an identifier of one or more network entities, a geographical location, and a time duration. The affected PM attribute at least includes an identifier of a performance metric and an expected value of the performance metric. Considering an example, where an ML model is deployed to optimize coverage (Inference Name: CoverageProblemAnalysis) and provides recommendations to create/delete the beam(s), change the transmission power of an associated network entity. However, if the provided recommendations are executed then the energy consumption performance indicator may increase. Thus, the MnS producer 116 generates impact information comprising affected scope and affected PM. The affected scope indicates information relating to all entities whose energy consumption is affected due to the ML model inference, and the affected PM attributes includes all KPI associated with energy consumption.

The communication network 101 may include, without limitation, generic provisioning management service as defined in 3GPP TS 28.532, a direct interconnection, local area network (LAN), wide area network (WAN), wireless network (e.g., using wireless application protocol), the internet, etc.

At operation 304, an occurrence of a performance degradation event in the communication network is detected based on the impact information. In one embodiment, the detection includes monitoring the communication network 101 based on the affected PM attribute of the impact information.

At operation 306, upon detection of the performance degradation event, at least one target ML model is identified from the one or more ML models which is causing the performance degradation event, based on the impact information and historical inference reports.

At operation 308, one or more remedial actions for managing the performance impact caused due to the at least one target ML model are performed. The performing of the one or more remedial actions includes deactivating an inference function of the at least one target ML model and updating an inference function of the at least one target ML model.

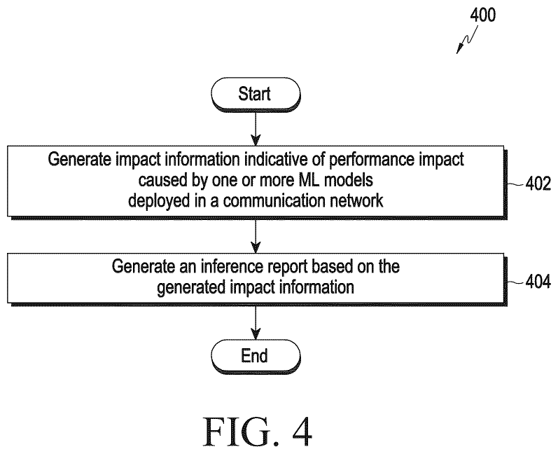

FIG. 4 shows a flow chart of a method 400 of generating impact information associated with a performance of a communication network, according to an embodiment of the disclosure.

Referring to FIG. 4, the method 400 includes one or more steps. The method 400 may be described in the general context of computer executable instructions. Generally, computer executable instructions can include routines, programs, objects, components, data structures, procedures, modules, and functions, which perform particular functions or implement particular abstract data types. In one embodiment, the functionalities of the method may be performed by a MnS producer 204 or the at least one processor of a MnS producer 204.

The order in which the method 400 is described is not intended to be construed as a limitation, and any number of the described method blocks can be combined in any order to implement the method. Additionally, individual blocks may be deleted from the methods without departing from the scope of the subject matter described herein. Furthermore, the method can be implemented in any suitable hardware, software, firmware, or combination thereof.

At operation 402, impact information indicative of performance impact caused by one or more ML models deployed in the communication network 101 is generated.

At operation 404, an inference report is generated based on the generated impact information.

The disclosure provides various technical advantages. The MnS producer by including the impact information in the inference report benefits in understanding the potential impact an ML model may have on the network. The impact of the ML model may be based on the impacted nodes or entities and impacted performance measurements such as throughput, latency, QoS. Further, the disclosure facilitates monitoring the network for a performance degradation event. Upon detection of the event, the responsible ML model is identified, and appropriate remedial action may be taken to mitigate or minimize the performance degradation. Therefore, techniques of the disclosure effectively manages the performance of a network.

The techniques of the disclosure keeps the MnS consumer updated about the potential impact of the ML recommendations, such that in an event of performance degradation (i.e., in present scenario increased energy consumption) the MnS consumer do not have to undergo a hectic process of monitoring the whole network, track the configuration performed by the ML models, compare all such models and then identify the ML model which is responsible for KPI degradation. Thus, the technique of the disclosure enables MnS consumer to effectively manage the performance of the network.

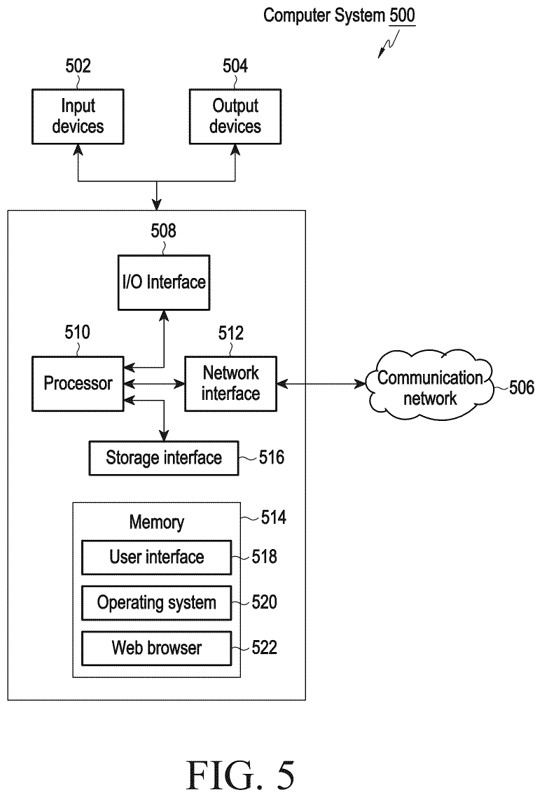

FIG. 5 illustrates a block diagram of a computer system 500 for implementing embodiments consistent with according to an embodiment of the disclosure.

Referring to FIG. 5, the computer system 500 may be used to implement the methods 300 and 400. Accordingly, the computer system 500 may be implemented as a MnS consumer 202 or a MnS producer 204. The computer system 500 includes a central processing unit 510 (also referred as “CPU” or “processor”). The methods 300 and 400 may be implemented by the processor 510. The processor 510 may include specialized processing units such as integrated system (bus) controllers, memory management control units, floating point units, graphics processing units, digital signal processing units, etc.

The processor 510 may be disposed in communication with one or more input/output (I/O) devices 502 and 504 via I/O interface 508. The I/O interface 508 may employ communication protocols/methods such as, without limitation, audio, analog, digital, monoaural, RCA, stereo, serial bus, universal serial bus (USB), infrared, PS/2, BNC, coaxial, component, composite, digital visual interface (DVI), high-definition multimedia interface (HDMI), radio frequency (RF) antennas, S-Video, VGA, IEEE 802.n/b/g/n/x, Bluetooth, cellular (e.g., code-division multiple access (CDMA), high-speed packet access (HSPA+), global system for mobile communications (GSM), long-term evolution (LTE), WiMax, or the like), etc.

Using the I/O interface 508, the computer system 500 may communicate with one or more I/O devices. For example, the input devices 502 may be an antenna, keyboard, mouse, joystick, (infrared) remote control, camera, card reader, fax machine, dongle, biometric reader, microphone, touch screen, touchpad, trackball, stylus, scanner, storage device, transceiver, video device/source, etc. The output devices 504 may be a printer, fax machine, video display (e.g., cathode ray tube (CRT), liquid crystal display (LCD), light-emitting diode (LED), plasma, plasma display panel (PDP), organic light-emitting diode display (OLED) or the like), audio speaker, etc.

The processor 510 may be disposed in communication with the communication network 506 via a network interface 512. The network interface 512 may communicate with the communication network 506. The network interface 512 may employ connection protocols including, without limitation, direct connect, ethernet (e.g., twisted pair 10/100/1000 Base T), transmission control protocol/internet protocol (TCP/IP), token ring, IEEE 802.11a/b/g/n/x, etc. The communication network 506 may include, without limitation, a direct interconnection, local area network (LAN), wide area network (WAN), wireless network (e.g., using wireless application protocol), the Internet, etc. The network interface 512 may employ connection protocols include, but not limited to, direct connect, ethernet (e.g., twisted pair 10/100/1000 Base T), transmission control protocol/internet protocol (TCP/IP), token ring, IEEE 802.11a/b/g/n/x, etc.

The communication network 506 includes, but is not limited to, a direct interconnection, an e-commerce network, a peer to peer (P2P) network, local area network (LAN), wide area network (WAN), wireless network (e.g., using wireless application protocol), the Internet, Wi-Fi, and such.

In some embodiments, the processor 510 may be disposed in communication with memory 514 (e.g., RAM, ROM, etc. not shown in FIG. 5) via a storage interface 516. The storage interface 516 may connect to memory 514 including, without limitation, memory drives, removable disc drives, etc., employing connection protocols such as serial advanced technology attachment (SATA), integrated drive electronics (IDE), IEEE-1394, universal serial bus (USB), fiber channel, small computer systems interface (SCSI), etc. The memory drives may further include a drum, magnetic disc drive, magneto-optical drive, optical drive, redundant array of independent discs (RAID), solid-state memory devices, solid-state drives, etc.

The memory 514 may store a collection of program or database components, including, without limitation, user interface 518, an operating system 520, web browser 522 etc. In some embodiments, computer system 500 may store user/application data, such as, the data, variables, records, etc., as described in this disclosure. Such databases may be implemented as fault-tolerant, relational, scalable, secure databases such as Oracle® or Sybase®.

The operating system 520 may facilitate resource management and operation of the computer system 500. Examples of operating systems include, without limitation, APPLE MACINTOSH® OS X, UNIX®, UNIX-like system distributions (E.G., BERKELEY SOFTWARE DISTRIBUTION™ (BSD), FREEBSD™, NETBSD™, OPENBSD™, etc.), LINUX DISTRIBUTIONS™ (E.G., RED HAT™, UBUNTU™, KUBUNTU™, etc.), IBM™ OS/2, MICROSOFT™ WINDOWS™ (XP™, VISTA™/7/8, 10 etc.), APPLE® IOS™, GOOGLE® ANDROID™, BLACKBERRY® OS, or the like.

The computer system 500 may implement the web browser 522 stored program component. The web browser 522 may be a hypertext viewing application, for example MICROSOFT® INTERNET EXPLORER™, GOOGLE® CHROME™, MOZILLA® FIREFOX™, APPLE® SAFARI™, and the like. Secure web browsing may be provided using secure hypertext transport protocol (HTTPS), secure sockets layer (SSL), transport layer security (TLS), etc. web browsers 522 may utilize facilities such as AJAX™, DHTML™, ADOBER FLASH™, JAVASCRIPT™, JAVA™, application programming interfaces (APIs), etc. In some embodiments, the computer system 500 may implement a mail server (not shown in FIG. 5) stored program component. The mail server may be an Internet mail server such as Microsoft Exchange, or the like. The mail server may utilize facilities such as ASP™, ACTIVEX™, ANSI™ C++/C#, MICROSOFT®, .NET™, CGI SCRIPTS™, JAVA™, JAVASCRIPT™, PERL™, PHP™, PYTHON™, WEBOBJECTS™, etc. The mail server may utilize communication protocols such as internet message access protocol (IMAP), messaging application programming interface (MAPI), MICROSOFT® exchange, post office protocol (POP), simple mail transfer protocol (SMTP), or the like. In some embodiments, the computer system 500 may implement a mail client stored program component. The mail client (not shown in FIG. 5) may be a mail viewing application, such as APPLE® MAIL™, MICROSOFT® ENTOURAGE™, MICROSOFT® OUTLOOK™, MOZILLA® THUNDERBIRD™, etc.

Furthermore, one or more computer-readable storage media may be utilized in implementing embodiments consistent with the disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., be non-transitory. Examples include random access memory (RAM), read-only memory (ROM), volatile memory, non-volatile memory, hard drives, compact disc read-only memory (CD ROMs), digital video disc (DVDs), flash drives, disks, and any other known physical storage media.

The terms “an embodiment”, “embodiment”, “embodiments”, “the embodiment”, “the embodiments”, “one or more embodiments”, “some embodiments”, and “one embodiment” mean “one or more (but not all) embodiments of the disclosure(s)” unless expressly specified otherwise.

The terms “including”, “comprising”, “having” and variations thereof mean “including but not limited to”, unless expressly specified otherwise.

The enumerated listing of items does not imply that any or all of the items are mutually exclusive, unless expressly specified otherwise. The terms “a”, “an” and “the” mean “one or more”, unless expressly specified otherwise.

A description of an embodiment with several components in communication with each other does not imply that all such components are required. On the contrary a variety of optional components are described to illustrate the wide variety of possible embodiments of the disclosure.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article or a different number of devices/articles may be used instead of the shown number of devices or programs. The functionality and/or the features of a device may be alternatively embodied by one or more other devices which are not explicitly described as having such functionality/features. Thus, other embodiments of the disclosure need not include the device itself.

The illustrated operations of FIGS. 2 to 4 show certain events occurring in a certain order. In alternative embodiments, certain operations may be performed in a different order, modified, or removed. Moreover, steps may be added to the above described logic and still conform to the described embodiments. Further, operations described herein may occur sequentially or certain operations may be processed in parallel. Yet further, operations may be performed by a single processing unit or by distributed processing units.

Finally, the language used in the specification has been principally selected for readability and instructional purposes, and it may not have been selected to delineate or circumscribe the inventive subject matter. It is therefore intended that the scope of the disclosure be limited not by this detailed description, but rather by any claims that issue on an application based here on. Accordingly, the disclosure of the embodiments of the disclosure is intended to be illustrative, but not limiting, of the scope of the disclosure, which is set forth in the following claims.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device individually or collectively, cause the electronic device to perform a method of the disclosure.

Any such software may be stored in the form of volatile or non-volatile storage such as, for example, a storage device like read only memory (ROM), whether erasable or rewritable or not, or in the form of memory such as, for example, random access memory (RAM), memory chips, device or integrated circuits or on an optically or magnetically readable medium such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method as claimed in any one of the claims of this specification and a non-transitory machine-readable storage storing such a program.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A method of managing impact of machine learning (ML) model inferences in a communication network, the method comprising:
receiving, from a management service (MnS) producer, an inference report comprising impact information indicative of performance impact caused by one or more ML models deployed in a communication network and historical inference reports;
detecting an occurrence of a performance degradation event in the communication network based on the impact information;
upon detection of the performance degradation event, identifying at least one target ML model from the one or more ML models which is causing the performance degradation event, based on the impact information and the historical inference reports; and
performing one or more actions for managing the performance impact caused due to the at least one target ML model.

2. The method of claim 1, wherein the impact information comprises a set of attributes comprising an affected scope and an affected performance measurement (PM).

3. The method of claim 2, wherein the affected scope attribute comprises at least one of an identifier of one or more network entities, a geographical location, or a time duration.

4. The method of claim 2, wherein the affected PM attribute comprises an identifier of a performance metric.

5. The method of claim 2, wherein the affected scope indicates information relating to entities having an energy consumption affected by ML model inference.

6. The method of claim 2, wherein the affected PM includes all key performance indicators (KPI) associated with the energy consumption.

7. The method of claim 1, wherein detecting the occurrence of the performance degradation event, comprises:
monitoring the communication network based on an affected performance measurement (PM) attribute of the impact information.

8. The method of claim 1, wherein performing the one or more actions comprises:
deactivating an inference function of the at least one target ML model; and
updating an inference function of the at least one target ML model.

9. A management service (MnS) consumer to manage impact of machine learning (ML) model inferences in a communication network, the MnS consumer comprising:
memory, comprising one or more storage media, storing instructions; and
at least one processor communicatively coupled to the memory,
wherein the instructions, when executed by the at least one processor individually or collectively, cause the MnS consumer to:
receive from a MnS producer, an inference report comprising impact information indicative of performance impact caused by one or more ML models deployed in a communication network and historical inference reports,
detect an occurrence of a performance degradation event in the communication network based on the impact information,
upon detection of the performance degradation event, identify at least one target ML model from the one or more ML models which is causing the performance degradation event, based on the impact information and the historical inference reports, and
perform one or more actions for managing the performance impact caused due to the at least one target ML model.

10. The MnS consumer of claim 9, wherein the impact information comprises a set of attributes comprising an affected scope and an affected performance measurement (PM).

11. The MnS consumer of claim 10, wherein the affected scope comprises at least one of an identifier of one or more network entities, a geographical location, or a time duration.

12. The MnS consumer of claim 10, wherein the affected PM comprises an identifier of a performance metric.

13. The MnS consumer of claim 10, wherein the affected scope indicates information relating to entities having an energy consumption affected by ML model inference.

14. The MnS consumer of claim 10, wherein the affected PM includes all key performance indicators (KPI) associated with the energy consumption.

15. The MnS consumer of claim 9, wherein the instructions, when executed by the at least one processor individually or collectively, further cause the MnS consumer to, as part of detecting the occurrence of the performance degradation event, monitor the communication network based on an affected performance measurement (PM) attribute of the impact information.

16. The MnS consumer of claim 15, wherein the instructions, when executed by the at least one processor individually or collectively, further cause the MnS consumer to perform the one or more actions by
deactivating an inference function of the at least one target ML model; and
updating an inference function of the at least one target ML model.

17. One or more non-transitory computer-readable storage media storing one or more computer programs including computer-executable instructions that, when executed by one or more processors of an electronic device individually or collectively, cause the electronic device to perform operations, the operations comprising:
receiving from a management service (MnS) producer, an inference report comprising impact information indicative of performance impact caused by one or more machine language (ML) models deployed in a communication network and historical inference reports;
detecting an occurrence of a performance degradation event in the communication network based on the impact information;
upon detection of the performance degradation event, identifying at least one target ML model from the one or more ML models which is causing the performance degradation event, based on the impact information and the historical inference reports; and
performing one or more actions for managing the performance impact caused due to the at least one target ML model.

18. The one or more non-transitory computer-readable storage media of claim 17, wherein the impact information comprises a set of attributes comprising an affected scope and an affected performance measurement (PM).

19. The one or more non-transitory computer-readable storage media of claim 18, wherein the affected scope comprises at least one of an identifier of one or more network entities, a geographical location, or a time duration.

20. The one or more non-transitory computer-readable storage media of claim 18, wherein the affected PM comprises an identifier of a performance metric.
